(19) United States
(12) Patent Application Publication
(10) Pub. No.: US 2012/0189984 A1
(43) Pub. Date: Jul. 26, 2012

(54) APICAL CUTTING THREAD DENTAL IMPLANT

(76) Inventor: David LC Holmes, London (GB)

(21) Appl. No.: 13/014,187

(22) Filed: Jan. 26, 2011

(51) Int. Cl. A61C 8/00

(52) U.S. Cl. 433/174

(57) ABSTRACT

An endo-osseous implant has a roughly cylindrical shape with a threaded exterior surface and an internal cavity at the apical end. The internal cavity is open toward the apical end and it has threaded walls that taper toward the exterior surface of the implant to form an apical cutting edge where they meet the threads of the outer surface. A drill shorter in length than the implant, is used to form an osseous cavity in which the longer implant is secured. The implant threads may be self-taping. As a result, upon securing the implant to the osseous tissue, bone fragments and shavings are directed into the internal cavity. When the implant reaches the base of the cavity the cutting edge cuts into the base and further anchors the implant in place.

### BACKGROUND OF THE INVENTION

This invention relates to dental implants and, more particularly, to apical end modified dental implants for improved patient safety during surgical procedures, wherein osteotomy preparation (removal by drilling) of the bone is minimized to avoid permanent or temporary injury, including paraesthesia, and implant interlocking and mechanical/biological stability in the bone is maximized through increased implant-bone surface area, and mechanical stability.

It is common in the field of dental implants to use traditional drills and procedures to insert dental implants into the jawbone. In the field of the invention, it is standard procedure to effect the placement of implants by drilling or otherwise generating a sufficient cavity or bore within a patient's jawbone. The resulting cavity is configured in order to accept the insertion of a dental implant that is threaded or otherwise capable of being secured within the cavity. Therefore, the cavity introduced into the jawbone has dimensions that differ slightly from that of the implant. The current state of the art necessitates that the jawbone be subject to a variety of damaging stresses and possible additional damage during such a surgical procedure and that the cavity preparation be slightly longer (?larger) than the length of the implant to allow complete seating of the implant in the site.

Even when performed by expert practitioners, it is still possible for severe and lasting damage to be done to nerves, tissue and bone during an implant procedure. Furthermore, in spite of the use of calibrated measurements to ensure an implant will fit properly, it is difficult to evacuate a cavity such that the dimensions perfectly confirm to the implant. As a result, prior art implants suffer from poor stabilization, fitting or immobilization issues. These issues can lead to failure of the implant, or unnecessary further dental or surgical intervention.

Most prior art solutions to these problems seek to use self-securing threading implants to avoid some of the potential dangers inherent in the procedure. Through the use of self-tapping screw thread implants, it is possible to make more intimate contact with the bone and consequently increase the implant's initial stability. The self-tapping process generates fine bone chips that fall into the cavity or bore in the jawbone. These chips can promote the growth of new bone to anchor the implant in place. However, despite the presence in the prior art of implants with self-tapping screws threads that are used in pre-drilled cavities, there is a tendency for the bone chips to be caught between the implant threads and the walls of the cavity, which compression of the wall area that can cause the implant to fail. This can, and does result in damage to bone cells. If irreparable damage is done to the jawbone, osteonecrosis can result. Additionally, even when wielded by expert practitioners, the operation to place an implant can be complex and difficult.

The prior art has attempted to counteract or overcome the potentially hazardous issues with dental implants. Primarily, the prior art is concerned with overcoming the problem of generating bone shavings that can lead to compression of the bone in the surrounding cavity and other bone related complications. For Example, U.S. Pat. No. 4,932,868 (Re. 35,784) of Linkow et al. discloses a submergible screw-type implant has a channel through the threads that curves bone chips from the cavity as it is inserted. The channel also guides the chips to an internal chamber where the chips are collected and promote new bone growth. However, the threads of the Linkow implant do not extend to the apical end of the implant and thus do not provide a mechanical anchor for the implant in that area.

U.S. Pat. No. 5,871,356 to Guedj describes an endo-osseous dental implant that has an open proximal cross-section and leading to an inner implant cavity. The Guedj implant has an outer threaded cylindrical wall and two cutting edges at the apical end. Guedji prepares a pre-cavity formation in the bone by using a stepped drill to evacuate bone from the proposed implant site. The pre-cavity is cylindrical with a wider upper portion which can be engaged by the outer threads. A more narrow lower part can be engaged by the apical cutting ends so that during installation bone chips are generated and are captured in the inner implant cavity. The threaded implant is then threaded into the pre-drilled cavity. The Guedj implant is rather long. Thus, securing it in place may cause the cavity to punch through jawbones lacking in sufficient vertical bone height. Thus, it has stability issues surrounding implant to bone contact (not sure if this sentence adds anything).

U.S. Pat. No. 6,866,508 to Aldecoa discloses a dental implant-carrier assembly with four cuttings areas at its apical end. The cutting areas radiate out from a flat part of the assembly until they reach a circular section. These implants have a slightly angled cutting face on their apical end. As the implant is secured into a pre-drilled cavity, the edges cut into the bone and generate bone chips. Aldecoa fails to provide an internal chamber in the implant allowing for the shepherding of bone shavings into such a space during the securing procedure. As a result the chips can be compacted in the base of the cavity. In addition, once the bone has integrated around this implant design, the resistance to vertical forces in this apical area and thus implant stability is reduced due to the reduced apical threads.

U.S. Published Patent Application No. 2006/0183079 to Galvan discloses a prosthesis implant for endo-osseous implantation, characterized in that it comprises an endo-osseous portion having, a milling cutter portion at an apical end thereof axially adjoining a tapping portion capable of cutting threads in the walls of a cavity in the bone. The tapping portion ends with a stabilizing thread portion. The endo-osseous portion is coupled to a prosthesis portion associated with a connection portion for connection to a surgical drill. The Galvan published application provides for an implant threaded into a cavity in a portion of bone tissue. However, like the Guedj implant, the Galvan implant is rather long and like the Aldecoa implant it fails to provide an interior cavity to contain bone shavings.

All of the cited prior art references, which are herein incorporated by reference, fail to adequately address some of the drawbacks still present in the field of the invention. Primarily, the cited prior art references still fail to adequately provide for a dental implant with a reduced profile to accommodate patients with narrow jawbones (lacking in sufficient vertical bone height). Furthermore, what is needed is an implant that has increased bio-mechanical stability across the entire structure. Additionally, what is needed is an implant that can be secured within the bone tissue while minimizing the possibility of permanent damage to a patient or the need for additional disruptive medical procedures.

### SUMMARY OF THE INVENTION

The present invention is directed to eliminating the drawbacks inherent in the prior art by providing a surgical implant for dental applications wherein the implant is cylindrically shaped and configured to have exterior and interior threading designed to enhance stability and minimize the risk of complications due to bone compression and damage when the implant is secured to the bone tissue.

The present invention uses an innovative design wherein the apical end of a threaded implant is configured to have an interior cavity that is also threaded. Due to this design, it is possible to provide an implant that has a significantly smaller profile when inserted into the bone. More importantly, because of its reduced size, it is possible that the dimensions of the pre-drilled cavity necessary for the implant are smaller than those envisioned in the prior art. Furthermore, by providing an apical end of the implant with an interior cavity that is threaded, the surface area of the entire implant is maximized. The resulting increase in the implant's surface area provides for enhanced stability and positioning. Overall the coupling of the implant to the bone is improved.

In an illustrative embodiment of the invention, the surgical implant device is configured to be a cylindrical submergible dental implant that is to be secured within the jawbone of a patient. The top of the cylindrical dental implant possesses a threaded hole that is adapted to receive an implant cover in the form of an abutment and crown formed to mimic a biological tooth (in the form of either an ‘external connection’ as described in the embodiment or an ‘internal connection’). The external edges of the implant are configured with cutting threads to assist in the securing of the implant into the jaw bone. At the apical end of the cylindrical implant body, the implant has an internal cavity formed within the structure and which is open at the apical end. The internal cavity is sufficiently conical, cylindrical or dome shaped (or other shape) so that the apical end of the implant tapers to form cutting edges that can cut into the base of the cavity. The interior surface of the internal cavity has threading designed in both pitch and angle to allow the implant to both secure and direct bone shavings into the internal cavity when the implant is installed in the bone tissue. Through the internal and external threads, the cutting surface area of the implant is greatly increased. As such, the dimensions of both the pre-implant drill bore and the eventual implant itself can be smaller than those described in the prior art. Furthermore, the increased surface area allows for the overall device to be smaller and more compact. Due to its compact size, it is easier to locate the provided implant next to a nerve, or other sensitive area, or to use it in a patient with a narrow jawbone either naturally or due to bone loss.

The foregoing and other objects and advantages of the present invention will be apparent from the description to follow. Additional features, advantages, and embodiments of the invention may be set forth or apparent from consideration of the following detailed description, drawings, and claims. It is to be understood that both the foregoing summary of the invention and the following detailed description are exemplary and intended to provide further explanation without limiting the scope of the invention as claimed.

### BRIEF DESCRIPTION OF THE DRAWINGS

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

The accompanying drawings, which are included to provide a further understanding of the invention and are incorporated in and constitute a part of this specification, illustrate preferred embodiments of the invention and together with the detail description serve to explain the principles of the invention in which:

FIG. 1 is a cross-sectional view of an illustrative embodiment of the prior art;

FIG. 2 is a cross-sectional view of an illustrative embodiment of the invention;

FIG. 3 is a cross-sectional view of an illustrative embodiment of a prior art implant compared with a prior art drill bit;

FIG. 4 is a cross-sectional view of an illustrative embodiment of an implant according to the present invention compared with a suitable drill bit showing that both have a smaller profile than the prior art;

FIGS. 5A-5F are an illustration in cross-section of the process according to an embodiment of the present invention of forming a cavity in the jawbone and securing an implant according to the present invention in that pre-drilled cavity; and

FIG. 6 is a cross-sectional view of an illustrative embodiment of the invention provided with an attached abutment or crown.

### DESCRIPTION OF ILLUSTRATIVE EXEMPLARY EMBODIMENTS

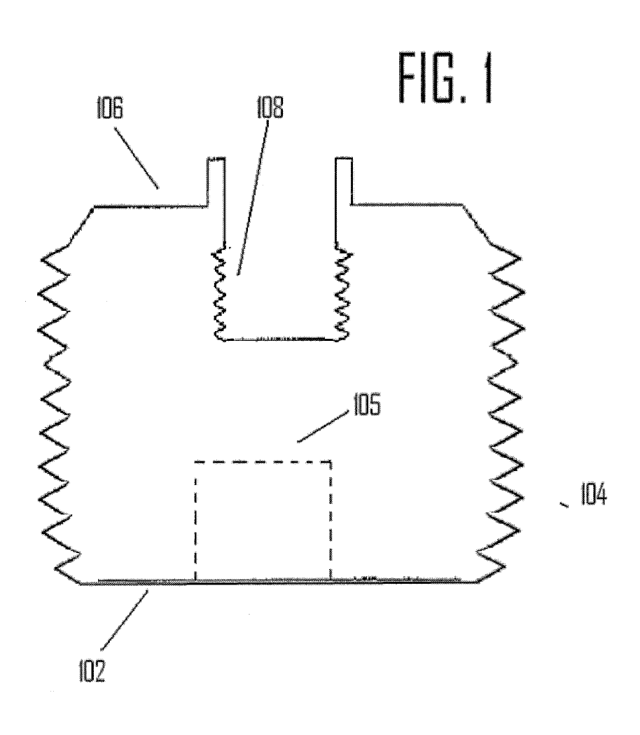

As seen in FIG. 1, a traditional dental implant as provided in the prior art is illustrated. The prior art dental implant has a roughly cylindrical shape designed to fit within a corresponding hole drilled into a portion of a patient's jawbone. A traditional implant possess an apical end 102 that is substantially flat and is designed to maximize contact between the apical end 102 of the implant and the bottom portion of the pre-drilled cavity in the jawbone. In order to assist in the stability of the prior art implant, exterior threads 104 are provided on the exterior of the implant so as to cut and thread their way into the sides of the pre-drilled cavity. Some prior implants contain an interior cavity 105 in which bone chips created by the threading operation may be stored. Furthermore, the implant possesses a coronal end 106 which is adapted to secure an abutment or crown attachment by means of a threaded recess 108 or other securing mechanism.

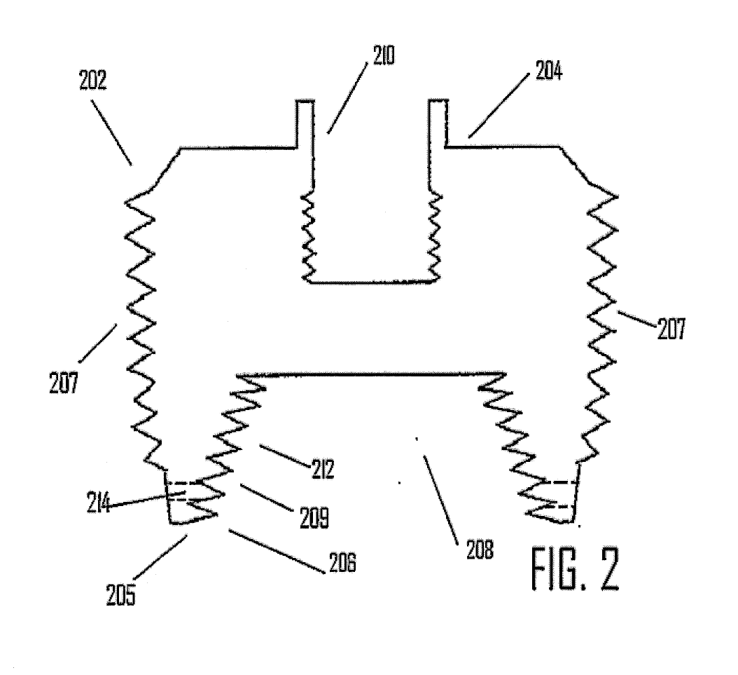

As seen in FIG. 2, an embodiment of the present invention is depicted in cross-section. FIG. 2 illustrates an embodiment of the present invention that includes an implant body 202 with a roughly cylindrical exterior profile. The illustrated embodiment also possesses a coronal end 204 at a top portion of the implant body, and an apical end 206 at the bottom portion of the implant body 202. The coronal end 204 possesses a means for the securing and attaching a crown or abutment to the implant. In a preferred embodiment, the coronal end 204 of the implant possesses a cavity 210 that is threaded to accept the insertion of a screw connected to an abutment or crown. This screw-based attachment may be conformed so that upon fully threading the screw into the implant the crown or abutment sits flush to the implant. Furthermore an additional embodiment may include an internal abutment connection.

The illustrated embodiment in FIG. 2 also possesses an internal chamber 208. The dimensions of the interior chamber 208 are such that it is roughly conical in shape, with the narrow portion closer to the coronal end 204 and the wider portion toward the apical end 206. This conical shape causes the interior wall 209 of the cavity at its wider portion and the exterior wall 207 of the implant body to taper toward each other at the apical end 206 to form a cutting edge 205. The exterior wall 207 of the implant body is threaded to assist in the securing of an implant within the pre-drilled cavity in the bone. The threads may have a channel through them (not shown) which causes the threads to be self tapping as is well known in the prior art.

In addition to the exterior threads of the implant body, the surface of the interior chamber also has threading. The internal threading 212 of the internal chamber 208 is designed and configured to direct bone shavings into the conical interior cavity. The internal chamber 208 can have different dimensions than those provided here. In no way limiting the embodiments envisioned by the present invention, it is possible to form the internal chamber 208 as a dome, semi-circle, cylindrical or conical shape. Furthermore, the pitch and angle of the internal threads 212 in the internal chamber 208 are configured to guide bone shavings into the interior chamber. The threads 212 of the internal cavity 208 are also provided to increase the surface area of the implant, and thus aid in stability. Further, a channel 214 can be provided between the external surface 207 and the internal chamber 208 so that bone chips created by the threads on the exterior surface can fall below the last exterior thread and pass into the internal chamber. To assist in this the channel 214 can slope downward from the external surface to the internal chamber. In this way bone chips from the external threads are not compacted as the insert is installed.

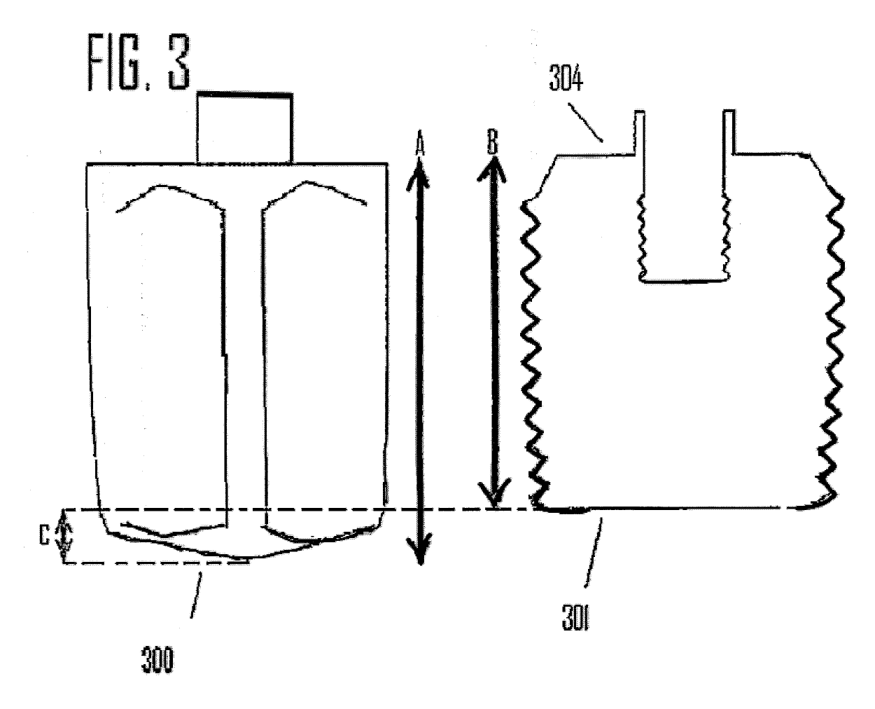

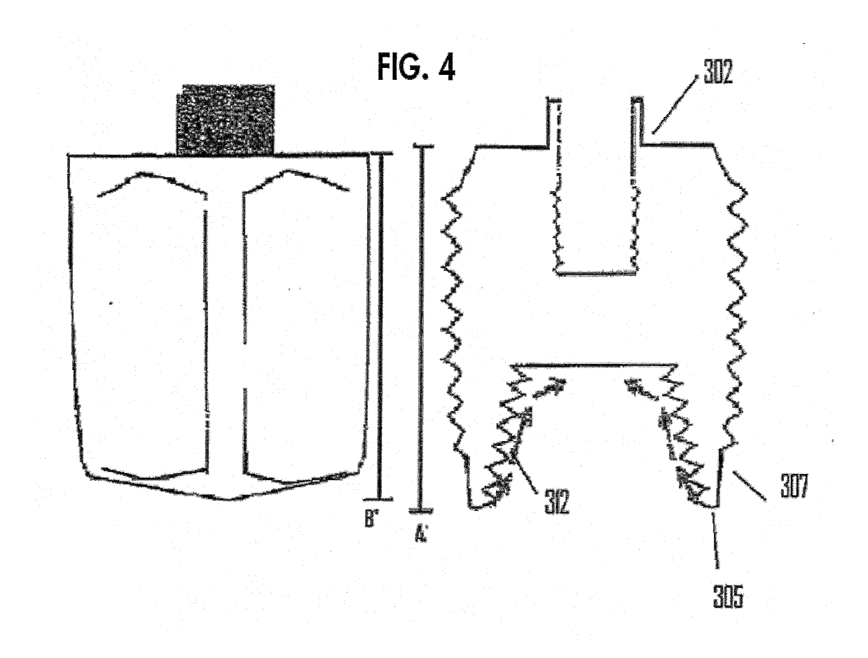

As shown in FIG. 3, a drill 300 used to create the bone cavity in the prior art has a length A that is longer than the length B of prior art implant. This is due to the necessity of providing a drilled cavity that is sufficient to allow the bone shavings to be evacuated. The prior art implant 301, once inserted into the bone cavity, is positioned so that a top portion or coronal end 304 of the implant is secured at a level that is flush with the top surface of the bone. However, as can be seen in the referenced figure, the drill bit provides an increased depth C at the center of the cavity. Upon insertion of a traditional implant 301, this increased center depth C provides for circumstances wherein the implant is insecurely fastened to the bone because it is not anchored at the bottom. Furthermore, un-evacuated bone fragments and shavings will collect in this depression, further providing opportunities for damage to the bone and surrounding tissues. In reference to FIG. 4, it is clear this embodiment of the present invention provides for not only the improved dental implant 302, but of a drill bit 310 that has dimensions that are shorter than the implant 314. In particular, the length A′ of the implant 314 is longer than the length B′ of the drill 310. Further, the overall lengths of the implant and drill, i.e., A′ and B′, are significantly shorter than those of the prior art implants, i.e., A and B in FIG. 3. Since the drill of this embodiment of the invention is shorter than the implant, and both the drill and implant can be made with a profile that is shorter than the prior art, the present invention provides an improved solution for patients with narrow jawbones. This shorter implant is possible because the invention provides superior anchoring of the implant in the bone, particularly at the apical end.

The implant 302 of FIG. 4 has an internal chamber with tapered and threaded walls 312 designed to cut into bone. These walls 312 also form a cutting edge 305 where they intersect with the exterior walls 307. As shown by the arrows in FIG. 4, the threads on wall 312 are designed to lead bone chips formed during insertion up into the internal chamber 308.

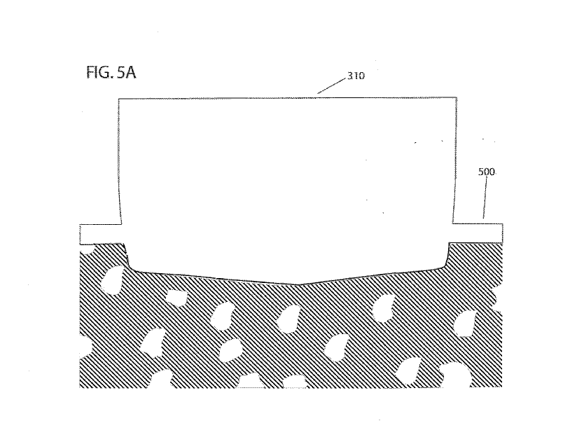

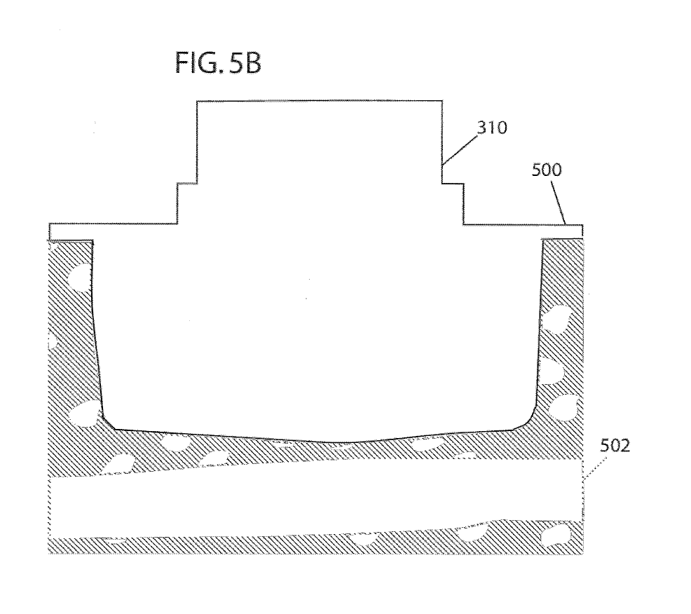

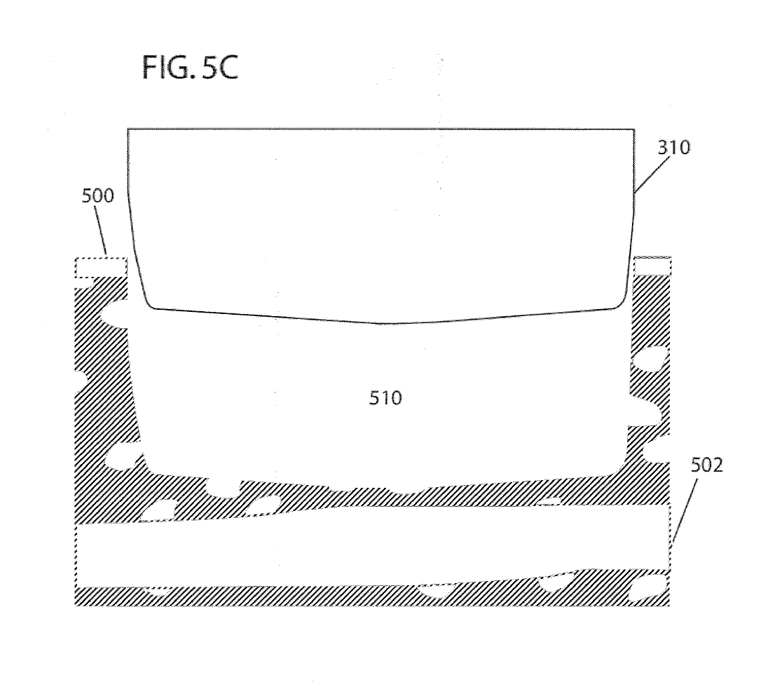

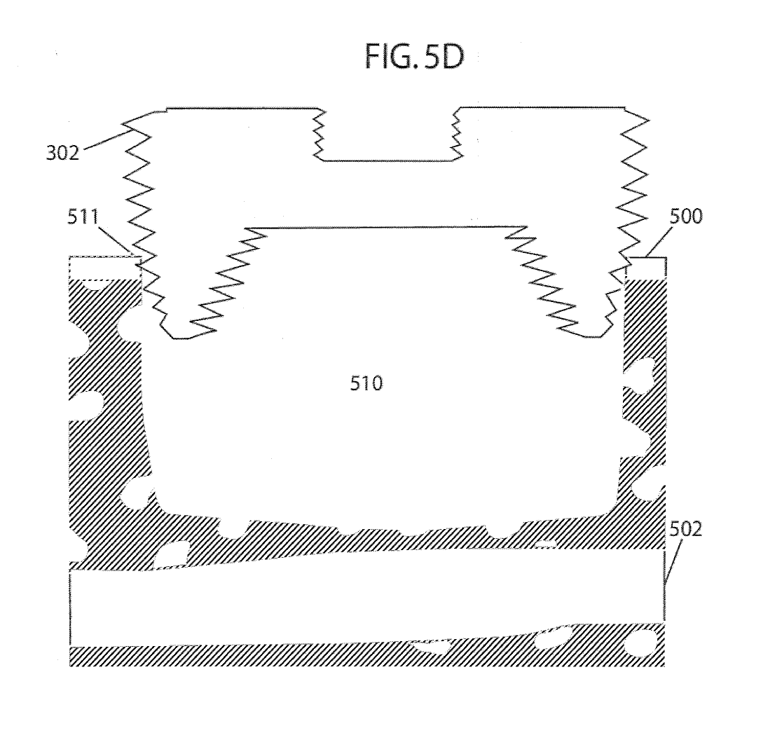

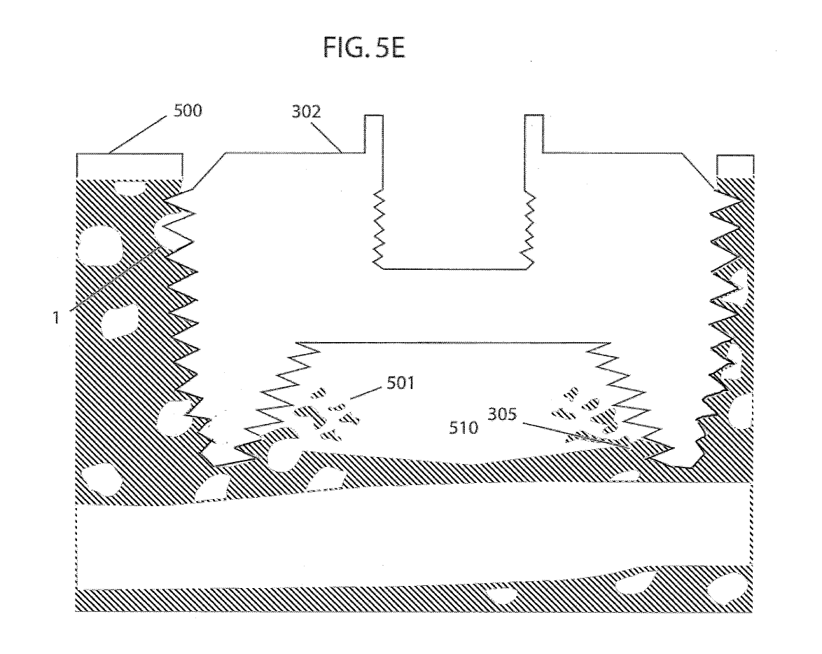

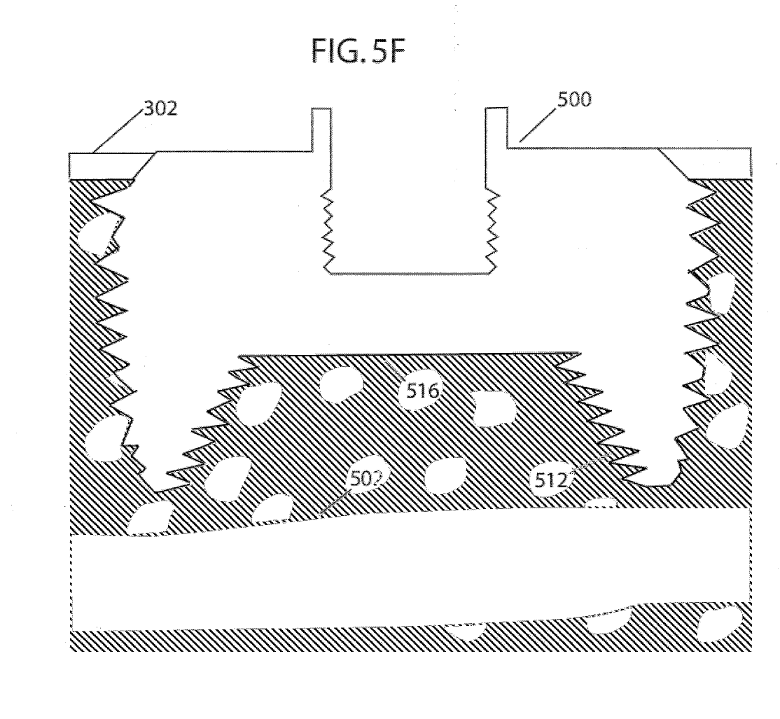

The process of inserting the implant in the patient's jawbone is illustrated in FIGS. 5A-5G. FIG. 5A shows the drill 310 beginning the process of creating a cavity in the patient's jawbone 500. In FIG. 5B the drill has been inserted in the bone as far as necessary. As can be seen, because of the relatively short profile of the drill, it does not contact the nerve bundle 502 that is located in the jawbone 500, FIG. 5C shows the drill 310 being removed from the jawbone and leaving behind the pre-drilled bore or bone cavity 510.

In FIG. 5D the implant 302 is shown being inserted into pre-drilled cavity 510. Self tapping external threads on the implant cut grooves into the walls of the cavity 501 at location 511 as the implant is screwed into place. Using self-taping threads on implant 302 allows for an intimate contact between the implant and the surrounding bone, which leads to better healing and a more stable fixing of the implant in the cavity. In FIG. 5E the implant is shown sufficiently secured into the pre-drilled cavity that the cutting edge 305 is beginning to cut into the base of the cavity 510. The result is the generation of bone chips 501 in addition to those created by the self-taping threads on the exterior surface 307.

FIG. 5F shows the implant 302 securely fixed in the jawbone 500 of a patient. The threads of the internal cavity 312 and the apical end of the external treads provide additional stability to the implant by cutting into the bone at the base of cavity 510. In effect, they anchor the apical end of the implant in that bone shavings 501 are displaced upward by the apical ends of the implant into the dome of the internal cavity 308 of the implant when the implant is being secured into the pre-drilled cavity. The displacement of the bone shavings is aided by the internal threading of the internal chamber 308 of the implant. As a result, the chips formed during insertion will be in the area 516 between the dome of the implant internal cavity 308 and the section of bone at the base of the bone cavity. The pressure and compaction of these chips can be controlled by how far the implant is screwed into place. Thus, the conditions can be established such that the chips are not under such pressure that their cells die and cause harm to the patient, but instead survive and promote the growth of new bone that integrates with the upper threads of the implant. As a result, when the implant of the invention is secured in the pre-evacuated bone cavity, the stability of the implant is improved greatly over that of the prior art.

The implant provided is necessarily secured with more bone contact, relative to the dimensions of the drill, but is still superior to the prior art. For example, due to the larger drill bit of the prior art, the overall pre-drilled cavity must be inherently larger than the pre-drilled cavity of the present invention. This increased bone cavity size allows the possibility of increased bone damage and osteonecrosis due to insufficient or imprecise drilling position, diameter and depth. In contrast, as seen in FIG. 4, the present invention allows for a smaller, less intrusive cavity to be drilled into the bone. Further, the apical ends cut into the bone and direct bone shavings from the bottom of the pre-drilled bone cavity to the conical internal cavity. This is accomplished at a bone depth that is less invasive than that required for the prior art devices.

Furthermore, the interior and exterior threading provides for increased surface area of the implant relative to a prior art implant lacking internal cavities or internal cavities without threading. The added surface area of the present embodiment provides additional implant stability from both the interior and interior of the implant.

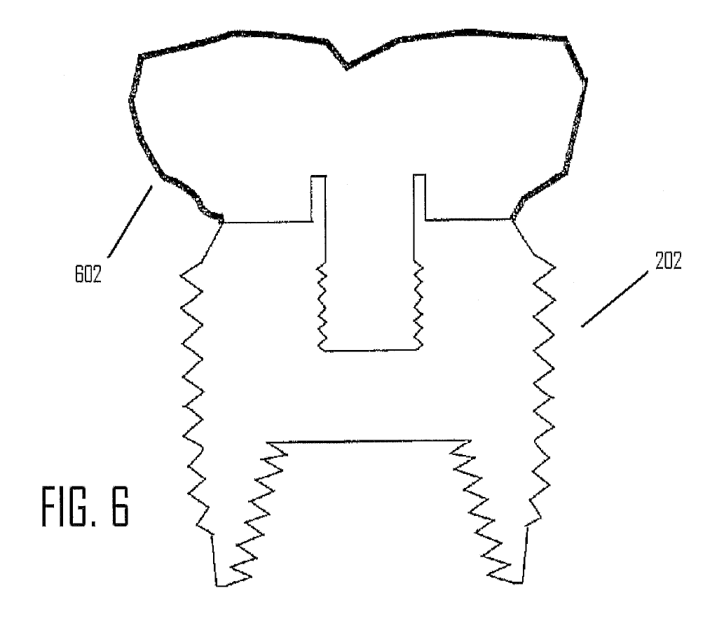

FIG. 6 depicts one embodiment of the present invention wherein a crown or abutment 602 is secured to the coronal insert located at the coronal end of the implant. The crown or abutment 602 is fully secured to the implant via a central screw into the implant. Furthermore the implant is designed to accept any commonly used crown or abutment. Additionally, even though the crown and abutment 602 are standard sized, because of the positioning of the safety implant according to the present invention, it is possible for a traditional implant and the illustrated embodiment of the present invention to be used on the same patient in close proximity. For example, the present invention envisions a prior implant of the manner previously described secured to the jawbone of a patient. When necessary, an implant according to the present invention may be inserted into the jawbone in a position that is close to that of the prior art implant. Due to its smaller dimensions, it is possible to secure the present invention in at a shallower depth than the prior art. As a result, the jawbone, which may have been compromised during the first implant procedure, is not excessively structurally compromised by the addition of the present invention implant. In the alternative, it is possible using the present invention to locate more implants at closer proximity to one another, due to cosmetic or medical necessity.

The present invention also foresees a method of providing a surgical dental implant to a patient with a reduced dimension implant. The envisioned methodology sees the following steps used to provide an implant. A first step of identifying a location for an implant to be secured. A subsequent preparing step wherein the surgical site is prepared for drilling and clearing operations necessary to prepare the jawbone for attachment of an implant. A further drilling step is envisioned, wherein a drilled cavity is evacuated from the jawbone by means of a drill or other cavity inducing mechanism. It is envisioned that the drill or other cavity inducing mechanism used in the evacuation creates a bone cavity wherein the dimensions, particularly length, are smaller than the proposed implant. An insertion step is envisioned, wherein the implant is partially inserted into the pre-drilled cavity and is secured to the jawbone by the action of the screw threads on the exterior of the implant. An additional securing step is envisioned, wherein the implant is fully inserted into the pre-drilled cavity and the apical cutter cuts into the base of the bone cavity and bone shavings are directed into the internal cavity of the implant. A third securing step is provided wherein the abutment or crown is attached by attaching means to the coronal end of the implant.

While the invention has been particularly shown and described with reference to preferred embodiments thereof, it will be understood by those skilled in the art that various changes in form and details may be made therein without departing from the spirit and scope of the invention.

1. A dental implant comprising:
a body configured to be submergible within a pre-drilled hole within a portion of a jawbone, said body having an apical end, a coronal end, and a cylindrical outer surface profile;
threads located over a major portion of the cylindrical outer surface profile of said body; and
interior walls forming an open internal chamber located at the apical end of said body, the interior walls of said internal chamber taper toward the outer surface of the body and form an apical cutting edge capable of cutting into the bone at the base of said pre-drilled hole, said walls of the internal chamber having threads over a major portion thereof, wherein the threads of the internal chamber and the threads of the outer surface meet at the apical end.

2. The dental implant according to claim 1 wherein the threads located over a major portion of the outer surface are self-tapping.

3. The dental implant according to claim 1 wherein the threads on the interior walls of the open internal chamber are self-tapping.

4. The dental implant according to claim 1, wherein the apical end of the implant is designed to direct bone shavings into the open internal chamber of the implant.

5. The dental implant according to claim 1, wherein interior walls of the open internal chamber define a cavity that is cylindrical, conical or dome shaped.

6. The dental implant according to claim 1, wherein the coronal end of the implant is adapted to be fitted with an abutment and crown utilizing either an internal or external abutment-implant connection.

7. The dental implant according to claim 1, wherein the dental implant is configured to replace an existing dental implant, and the dental implant is configured such that the cylindrical outer surface has a length that is relatively shorter than a length of the existing implant having a similar diameter to the dental implant.

8. Surgical equipment for dental implantation comprising a drilling instrument and a dental implant wherein:
the dental implant has a body configured to be submergible within a pre-drilled hole within a portion of a jawbone, said body having an apical end, a coronal end, and a cylindrical outer surface profile; said body further having external threads and
an inner chamber open toward the apical end;
wherein the open inner chamber of the implant has tapered, threaded walls that extend to the apical end; and wherein the length of the body of the drilling instrument is smaller than the length of the dental implant, and wherein the thread of the open internal chamber and the thread of the outer surface meet at the apical end.

9. The surgical equipment according to claim 8 wherein the dental implant possesses external threads that are self-tapping.

10. The surgical equipment according to claim 8, wherein the apical end of the dental implant has cutting threads that are designed to self-tap into a bottom of the pre-drilled hole in the jawbone.

11. The surgical equipment according to claim 8, wherein the apical end of the dental implant is designed to direct bone shavings into the internal chamber of the implant.

12. The surgical equipment according to claim 8, wherein the interior walls of the open inner chamber of the dental implant define a cavity that is cylindrical, conical or dome shaped.

13. The surgical equipment according to claim 8, wherein the coronal end of the dental implant is adapted to be fitted with an abutment and crown.

14. A method of securing a surgical dental implant in a jawbone comprising the steps of:
identifying a location for an implant to be secured,
preparing a surgical site for drilling and clearing operations necessary to prepare the jawbone for attachment of an implant;
drilling a cavity in the jawbone and evacuating debris from the cavity using a drill having a length shorter than that of the implant;
inserting an implant into the cavity, said implant having a coronal end and an apical end, with threads on its external surface and an internal chamber at the apical end with internal threads on its surface, wherein the threads on its external surface meet the threads of the internal chamber at the apical end,
securing the implant into the cavity by having an apical edge cut into the base of the cavity; and
guiding the bone shavings generated from the cut in the base of the cavity into the internal cavity of the implant.

15. (canceled)

16. The method according to claim 14 further including the step of securing an abutment or crown to the coronal end of the implant with attaching means.
